(19) United States
(12) Patent Application Publication
(10) Pub. No.: US 2011/0030365 A1
(43) Pub. Date: Feb. 10, 2011

(54) METHODS AND APPARATUS FOR ENERGY PRODUCTION

(75) Inventor: Shlomo GILBOA, Haifa (IL)

Correspondence Address: OLIFF & BERRIDGE, PLC, P.O. BOX 19928, ALEXANDRIA, VA, 22320, US

(73) Assignee: SEANERGY ELECTRIC LTD., Haifa (IL)

(21) Appl. No.: 12/826,053

(22) Filed: Jun. 29, 2010

Related U.S. Application Data
(63) Continuation-in-part of application No. PCT/IL2008/001700, filed on Dec. 31, 2008.

(51) Int. Cl. F03B 13/18

(52) U.S. Cl. 60/497

(57) ABSTRACT

The present invention discloses an energy production system converting the energy of moving liquid in a reservoir (e.g. sea waves) to extensive power through the use of a float. The energy production system comprises a liquid reservoir in which a liquid periodically changes its level, at least one float at least partially immerged in liquid within said liquid reservoir, a lock system operable to maintain said float at a predetermined base level in said liquid, and a controller system comprising a floating trigger system operable to selectively trigger said lock system to release the float from the base level to wave crest upon identifying a predetermined condition of the float relative to the liquid level thus enabling an outburst and creating high mechanical energy, thereby producing energy power from the liquid level difference within said liquid reservoir. The huge mechanical vertical power may then be transformed to an electrical power by using for example an electrical rotating turbine or an electric generator (e.g. linear) which is attached to the float. The mechanical power may also be used to generate a pressurized liquid by directly connecting between the float and a pump. The energy produced by the mechanical power may be transformed and used for any process requiring energy such as production of electricity, production of pressurized liquid, desalination of liquid, or creation of hydrogen/oxygen.

### FIELD OF THE INVENTION

The present invention relates generally to a method and apparatus for energy production using buoyancy forces.

### BACKGROUND OF THE INVENTION

Wave energy has been identified as one possible source of renewable energy. Various wave energy conversion devices have been proposed that aim to extract useful energy from wave motion in a body of liquid, such as the sea. Waves are created through the transfer of wind energy to the surface of bodies of water. Wave energy is propagated for long distances in deep water with minimal attenuation by interactive velocity and pressure fluctuations within the body of water.

Generally, wave energy conversion devices physically span the waves from crest to crest to provide a floating reference for the wave displacement forces.

Electricity Generation Wave Pump (EGWAP) devices typically incorporates a perforated, hollow, non corroding pipe having a total height expanding from the ocean floor to above the highest wave peak. The pipe is anchored securely beneath the ocean floor. When the water level in the pipe rises due to wave action, a float rises and a counterweight descends. This action turns a main drive gear and other gearings to turn a generator to produce electricity. The mechanism also insures that either up or down movement of the float will turn the generator drive gear in the same direction.

For example, many wave energy harvesters utilize alternating peaks and troughs of ocean waves to raise and lower part of the harvester to thereby extract mechanical energy from relative motions of at least two portions of the device. Motion of one portion of such devices is typically due to flotation on the rising and falling water surface as a wave passes the device which is in a relatively fixed position. Since the quantity of energy harvested is directly proportional to the weight of the device on the down stroke, or the buoyancy force on the upstroke, most known devices lag the wave. Typically, such devices sink as the water rises until relative buoyancy increases sufficiently to force the device upwards, and then emerge onto or above the water surface as the wave falls, since the downward stroke is used to extract energy from the device buoyant forces generated by the up-and-down motion of the wave, they are also known as point-absorbers.

In some floating point absorbers, the devices typically comprise a vertical axis having two-body wave energy converter: a buoy associated with an acceleration tube assembly; and a piston, wherein the water penetrates the acceleration tubes. As the buoy moves up and down on the surface of the waves, hose-pumps connected to the piston and to the ends of the acceleration tube expand and contract, resulting in a respective increase and decrease of the hose-pump internal volume, thus creating a pressurized water flow. The pumped water is directed into a conversion system consisting of a turbine driven generator. This device is typically tethered by a tension cable to surface floats being connected to subsurface mooring buoys and to vertical load anchors.

For point absorbers which use buoyancy as the predominant actuating force, a float or other buoyant portion is tethered to a structure below the surface and the upward pull on the tether transmits the force that is harvested as energy. In some of these devices, the buoyant floats are attached to a fixed point via a flexible tether, and therefore are subject to tilting of the float upon forward force impingement of a wave.

In other wave energy generator, known as Archimedes wave Swing (AWS) is a seabed point absorbing wave energy converter having a large air-filled cylinder which is submerged beneath the waves. As a wave crest approaches, the water pressure on the top of the cylinder increases and the upper part or ‘floater’ compresses the air within the cylinder to balance the pressures. The reverse happens as the wave trough passes and the cylinder expands. The relative movement between the floater and the fixed tower part is converted directly to electricity by means of a linear power takeoff. The machine is floated to the deployment site on a pontoon, sunk and sits on the bottom of the seabed.

Another power-buoy system consists of a floating buoy-like device that is loosely moored to the seabed so that it can freely move up and down in response to the rising and falling of the waves, as well as a power take off device, an electrical generator, a power electronics system and a control system, all of which are sealed in the unit. The power take off device converts the mechanical stroking created by the movement of the unit caused by ocean waves into rotational mechanical energy, which, in turn, drives the electrical generator. The power electronics system then conditions the output from the generator into usable electricity. The operation of the power-buoy is controlled by a customized control system.

### GENERAL DESCRIPTION

There is a need in the art in improving the energy harvesting of wave energy and the energy gain production process during the energy production using buoyancy forces, by converting the energy of moving liquid in a reservoir (e.g. sea waves) to extensive mechanical power through the use of a float. The buoyancy forces are the upward forces exerted on an object (float) produced by the surrounding liquid in which it is fully or partially immersed, due to the pressure difference of the liquid between the top and bottom of the float. The net upward buoyancy force is equal to the magnitude of the weight of liquid displaced by the body less the weight of the float. This force enables the object to float.

According to one broad aspect of the invention, there is provided a system configured and operable for production of mechanical energy from a change in a liquid level difference in (e.g. wave moving through) a liquid reservoir. The system comprises:

at least one liquid reservoir having a predetermined arrangement of inlet and outlet to provide a periodical change in a liquid level in the reservoir resulting from liquid passage through the reservoir via said inlet and outlet,

at least one float at least partially immersed in liquid within the liquid reservoir, a lock system operable to maintain said at least one float at a predetermined base level in said liquid, and a controller system comprising a trigger system operable to selectively trigger said lock system to release the float upon identifying a predetermined condition of the float relative to the liquid level thus enabling movement of the float creating high mechanical energy from the liquid level difference within said liquid reservoir, thereby enabling use of said high mechanical energy for producing energy

It should be noted that the wave energy resource may be recovered in the open sea, in the deep ocean, on or close to the shore line, i.e. on-shore or offshore. Waves or surges in a liquid contained in reservoirs (vessels or tanks) are also considered in the context of the present invention. Throughout this application, the terms “sea”, “seabed” or “ocean”, “ocean floor” may be used interchangeably and are not intended to be limiting. The apparatus of the present invention can be used in any reservoir of liquid where wave action occurs. In other words, a reservoir of liquid suitable to be used in the present invention is any reservoir in which a change in the liquid level periodically occurs. The reservoir has a predetermined arrangement of inlet and outlet located at different heights with respect to the reservoir to provide a periodical change in the liquid level in the reservoir induced by the liquid passage through the reservoir via the inlet and outlet. The periodical change may be assisted in a mechanical way (e.g. by opening and closing valve(s) of any suitable type connected to the inlet and/or outlet of liquid reservoir) or occurring in a natural way, in which waves change the water level in the sea itself or in a liquid reservoir in liquid communication with a water source (e.g. the sea).

The term “wave” refers to both waves on a surface of a liquid and swell in a reservoir of a liquid, currents, or any combination thereof. The liquid reservoir may be a closed reservoir or an open reservoir and may be employed with a natural liquid, e.g. sea water or river water or even sewage water. The reservoir may be a pool of a water tower (e.g. local), water gate, river, lake, sea, stream, ocean, dam, fresh water reservoirs, local sewage systems and drainers. The pool of water may be near shore in which the level of the water is determined according to the level of the wave offshore according to Bernoulli law and to the connected vessels principle.

It should be noted that in some embodiments, the controller system may be configured and operable to control said periodical change in the liquid level in the reservoir in accordance with a predetermined wave-model.

The float is preferably held on a predetermined base level of the liquid reservoir (e.g. sea) by a set of gate lockers. When the wave moves through the liquid reservoir and reaches its maximum height, a trigger releases the lockers, allowing the float to outburst, similar to a rocket, all the way to the wave peak creating large amount of energy. The huge mechanical vertical power may then be transformed to an electrical power by using for example an electrical rotating turbine or an electric generator (e.g. linear) which is attached to the float. The mechanical power may also be used to generate a pressurized liquid by directly connecting between the float and a pump. The energy produced by the mechanical power may be transformed and used for any process requiring energy such as production of electricity, production of pressurized liquid, desalination of liquid, or creation of hydrogen/oxygen.

According to another broad aspect of the invention, there is provided an energy production system comprising:
at least one liquid reservoir having a predetermined arrangement of inlet and outlet to provide a periodically changes in a liquid level in the reservoir resulting from liquid passage through the reservoir via said inlet and outlet,
at least one float at least partially immersed in liquid within said liquid reservoir, a lock system operable to maintain said at least one float at a predetermined base level in said liquid, and a controller system configured and operable to selectively operate said lock system to release the float upon identifying a predetermined condition of the float relative to the liquid level thus enabling movement of the float creating high mechanical energy from the liquid level difference within said liquid reservoir, thereby enabling use of said high mechanical energy for the energy production.
According to yet another broad aspect of the invention, there is provided a reverse osmosis system comprising:

a liquid reservoir configured such that a liquid periodically changes its level in the reservoir;

at least one float at least partially immersed in liquid within said liquid reservoir;

a lock system operable to controllably maintain said float at a predetermined base level in said liquid reservoir;

a controller system configured and operable to selectively operate said lock system to release the float upon identifying a predetermined condition of the float relative to the liquid level thus causing movement of the float creating high mechanical energy from the liquid level difference within said liquid reservoir; and

a reverse osmosis unit located in a path of the liquid passing through or emerging from said reservoir, the liquid being forced to pass through the reverse osmosis unit by said mechanical energy thus desalinating the liquid.

The liquid reservoir may be a pool of a liquid tower, liquid gate, river, lake, sea, stream, ocean, dam, fresh liquid reservoirs, local sewage systems and drainers.
In yet further aspect of the invention, it provides a system comprising a liquid reservoir in which liquid level periodically changes, and at least one float at least partially immerged in liquid within the liquid reservoir, a lock system operable to maintain said at least one float at a predetermined base level in said liquid, and a controller system comprising a trigger system operable to selectively trigger said lock system to release the float upon identifying a predetermined condition of the float relative to the liquid level thus enabling movement of the float creating high mechanical energy from the liquid level difference within said liquid reservoir, thereby enabling use of said high mechanical energy for energy production.

The predetermined base level may be the lowest liquid level in the liquid reservoir (e.g. the trough of the wave height). The predetermined condition of the float is thus its location at the lowest liquid level, the float being released from the lowest liquid level (e.g. at a peak crest of the wave downward) and locked again by the lock system.

Alternatively, the predetermined base level may be the highest liquid level, and accordingly the predetermined condition of the float corresponds to its location at the highest liquid level, in which case the float is released at the highest liquid level downward and locked again by the lock system.

The predetermined base level may be a trough of a wave height, in which case the float is released to a peak crest of the wave; or may be a top of the wave height, in which case the float is released.

In some embodiments, the float is released from a base level (e.g. level 0) vertically to the peak height of the wave crest.

In other embodiments, the float is held at the bottom of the liquid reservoir.

Alternatively, the float is held at the peak wave height, and released vertically to the base level (level 0), at a moment the wave is at its minimal energy level (minimal height or trough).

In some embodiments, the float is an elongated hollow member (e.g. hollow pipe). The float may have a length substantially equal to the highest liquid level in the reservoir. The float may have a length higher than the highest liquid level (e.g. having one end thereof above the liquid level (i.e. being above the liquid level)) keeping continually a portion of the float above the liquid level minimizing friction forces exerting on the float.

The float may be filled with a liquid having the same specific gravity as the liquid in which the float is immerged.

Preferably, the controller system includes one or more sensors operable to detect at least one of the following: the highest liquid level and the lowest liquid level (e.g. a condition of the peak of the crest wave or that of the trough of the wave height).

In other embodiments, the floating trigger system comprises a secondary float.

As indicated above, in some embodiments, the mechanical energy production system of the present invention is associated with a reverse osmosis unit for desalinating liquid passing therethrough. The reverse osmosis unit may be located in a path of the liquid passing through or emerging from the liquid reservoir; the liquid is forced to pass through the reverse osmosis unit by the mechanical energy (produced as described above) thus desalinating the liquid. The desalination of the liquid can thus be performed directly by wave energy using buoyancy forces, thereby eliminating a need for an external energy to activate the reverse osmosis unit.

In some embodiments, the energy production system comprises a transformer configured and operable to transform a linear movement of the float into a rotational movement. The transformer may comprise a rod (e.g. a rotational shaft) attached to the float; an impact transmitter having a polygonal (e.g. square) groove accommodating the rod; an inertial wheel operable to be locked together with the impact transmitter; and a generator having a main rod such that the linear motion of the rod is transformed into a rotational motion, rotating the main rod to produce electricity. The linear transformer may be configured to lengthen the production of electricity after the release of the float from the highest liquid level.

In some embodiments, the reverse osmosis unit might be associated with the above-described transformer. For example, a pump may be used being connected and driven by the generator or directly by the transformer for exerting a high pressure on the liquid, such that the pump assists in forcing the liquid to pass through the reverse osmosis unit desalinating the liquid.

In some embodiments, the system is associated with an electrolysis unit. The latter includes two electrodes submersed by the liquid and an electrical potential is created between the electrodes by a generator causing a current through the liquid between the electrodes during the liquid passage through the reservoir, inducing a portion of the liquid to dissociate into hydrogen and oxygen molecules by an electrolysis process. In some other embodiments, the electrolysis unit may be a part of the above-described transformer being connected to the generator and includes two electrodes oppositely charged by the generator.

The energy production system may comprise at least one separator separating the electrodes such that the hydrogen and the oxygen generated in the vicinity of each electrode, may be separately collected, or separately vented to the atmosphere. The energy production system may also comprise a compressor compressing the hydrogen gas for transmission and storage in the float.

In some embodiments, the energy production system may be configured to be operable on the land using an on-shore liquid reservoir. The liquid reservoir may be intended to be filled or emptied using gravity forces or using the connected vessels principle. The controller system may be operable to open and close the liquid reservoir in a liquid source, filling and emptying the reservoir from the liquid source using at least one of the following: gravity forces and connected vessels principle such that the liquid level in the liquid reservoir is highest than the liquid source level. The liquid in the reservoir may change its level with a certain constant periodicity and with the constant liquid level difference, enabling a continuous production of electricity.

As indicated above, the liquid reservoir may be selected from a pool of a liquid tower, liquid gate, river, lake, sea, stream, ocean, darn, fresh liquid reservoirs, local sewage systems and drainers.

In other embodiments, the energy production system comprises a hydraulic pump configured an operable as a lock system maintaining the float at a predetermined base level in the liquid and as a transformer operable to convert the mechanical linear motion of the float into an hydraulic pressurized liquid. The pump may comprise two one-way valves configured to allow the liquid to enter or to leave the hydraulic pump.

According to another broad aspect of the invention, there is provided a method of production of energy. The method comprises: providing liquid passage through a liquid reservoir with a periodical change of a liquid level in the reservoir, while holding a float at a predetermined level in the reservoir such that said float is at least partially immersed in a liquid within the liquid reservoir; and selectively releasing said float to allow said float to outburst using buoyancy forces creating large amount of mechanical energy.

The float may be released from a predetermined base level upwards. Alternatively, the float may be released from a high liquid level downwards. The selective release of the float may be carried out upon detecting the highest liquid level.

According to another broad aspect of the present invention, there is provided a float at least partially immerged in liquid within a liquid reservoir configured as an elongated hollow member.

According to a further broad aspect of the present invention, there is provided a linear transformer to be used with a float at least partially immerged in liquid within a liquid reservoir. The linear transformer comprises a rod attached to the float, an impact transmitter having a polygonal groove accommodating the rod, an inertial wheel operable to be locked together with the impact transmitter, and a generator having a main rod such that the linear motion of the rod is transformed into a rotational motion, rotating the main rod to produce electricity such that the linear transformer is configured and operable to transform a linear movement of the float into a rotational movement of an energy power generator.

In some embodiments, the linear transformer comprises a reverse osmosis unit and a pump exerting a high pressure on the liquid. The pump is connected and driven by the generator such that the pump forces the liquid to pass through the reverse osmosis unit desalinating the liquid.

In some embodiments, the linear transformer comprises an electrolysis unit connected to the generator including two electrodes oppositely charged by the generator. The electrodes are submersed by the liquid such that an electrical potential is created between the electrodes, causing an electrical current to flow through the liquid between the electrodes, inducing a portion of the liquid to dissociate into hydrogen and oxygen molecules by an electrolysis process.

### BRIEF DESCRIPTION OF THE FIGURES

In order to understand the invention and to see how it may be implemented in practice, and by way of non-limiting example only, with reference to the accompanying drawing, in which

FIG. 1 schematically illustrates a general schematic view of an example of an energy production system of the present invention;

FIG. 2 schematically illustrates a schematic view of the energy production process using the teachings of the present invention;

FIG. 3 schematically illustrates another schematic view of the energy production process;

FIG. 4 illustrates another configuration of an example of an energy production system;

FIGS. 5A-5B illustrate the use of a secondary float operable as a trigger according to the teachings of the present invention;

FIG. 6 is a schematic representation of a housing structure;

FIGS. 7A-7B are schematic representations of two examples of a linear transformer according to the teachings of the present invention; FIG. 7C is a schematic representation of the linear transformer of FIG. 7B configured and operable for liquid, desalination by using reverse osmosis process; FIG. 7D is a schematic representation of a Reverse Osmosis unit;

FIG. 8 is a schematic representation of a rotational transformer having a spiral rod.

FIG. 9 is a schematic representation of an on-shore reservoir; and;

FIG. 10 is a schematic representation of a land reservoir system.

### DETAILED DESCRIPTION OF THE EMBODIMENTS

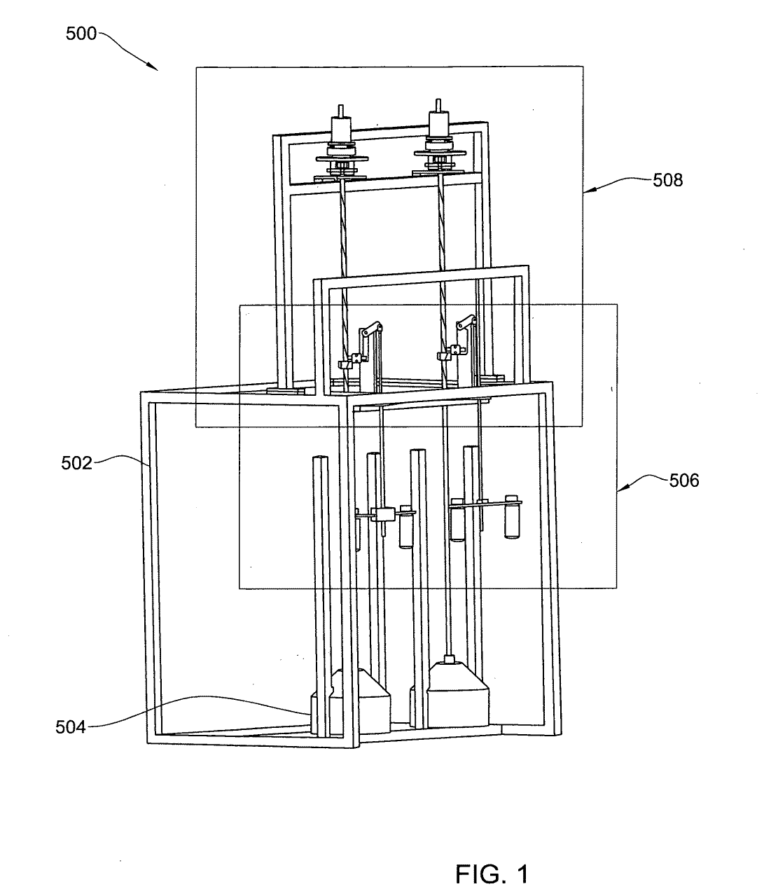

Reference is made to FIG. 1 illustrating a schematic representation of an energy production system 500. The system 500 comprises a liquid reservoir 502 in which a liquid periodically changes its level, at least one float 504 at least partially immerged in the liquid within said liquid reservoir, a lock system 506 operable to maintain said float at a predetermined base level in said liquid, and a controller system comprising a trigger (e.g. a secondary float not shown) operable to selectively trigger said lock system to release the float enabling its movement creating high mechanical energy, thereby producing energy power from the liquid level difference within said liquid reservoir. The energy production system 500 comprises a transformer 508 configured and operable to transform a linear movement of the float into a rotational movement of an energy power generator.

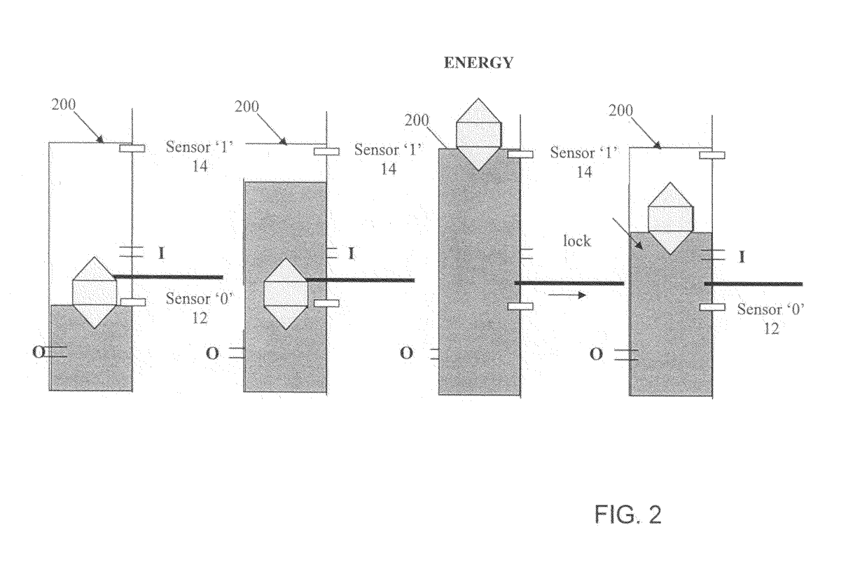

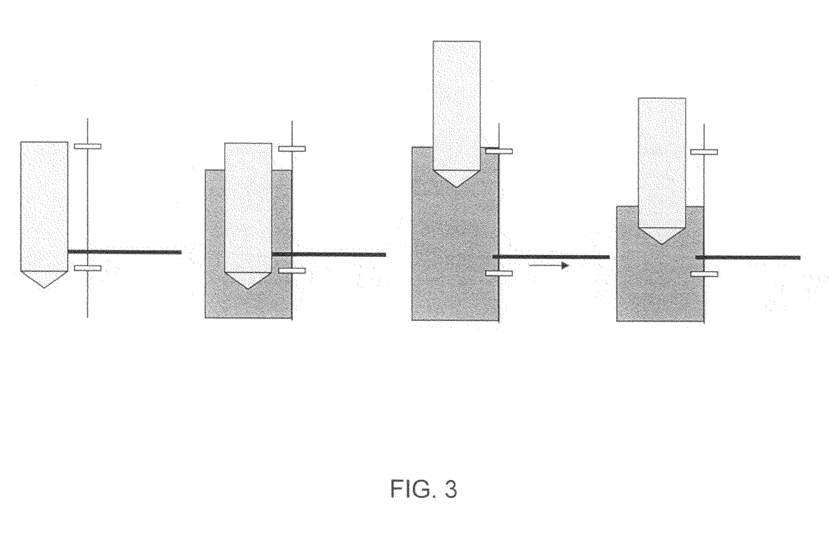

Reference is made to FIG. 2 illustrating an example of the energy production process used in the present invention. In the present example, the sea waves are considered, but it should be understood that the invention is not limited to this example, and a specifically design wave-model in a reservoir may be used.

In the first position (from left to right), a lock holds a float on a base sea level (‘0’). Once a wave covers the float (i.e. the float is completely immersed in the liquid) and approaches its maximum height (which may be identified by a sensor), a controller releases the trigger. The lock then opens up, allowing the float to be released to the peak crest of the wave. The sea level then goes back to the base level and the float floats down on liquid level. In this specific example, the float has a cone upper surface minimizing friction and loss of energy during the upward motion of the float.

The system of the present invention comprises one or more liquid reservoirs, although only one such liquid reservoir 200 is represented in the figure. The liquid reservoir 200 has a predetermined arrangement of inlet I and outlet O to induce a periodically change in a liquid level in the reservoir resulting from the liquid passage through the reservoir 200 via the inlet I and outlet O. The inlet I and outlet O are arranged at different heights with respect to each other to enable a liquid level difference to be periodically provided in the reservoir 200. The periodical change may be further assisted by a mechanical assembly (e.g. by opening and closing valve(s) at the inlet and/or outlet in liquid reservoir); or may occur in a natural way, in which waves change the water level in the sea itself or in a liquid reservoir while in liquid communication with a water source e.g. the sea.

Alternatively, the float of the present invention may be filled with a liquid having the same specific gravity that the liquid in which the float is immerged (e.g. the sea water). As long as the float average density is lower than the density of the liquid, the float would float on the top of the wave. When the float reaches the top height of the wave, the float is held at the peak height by a lock attached to a housing structure. When the water goes downwards back to sea level, the controller releases the trigger, allowing the lock to open and to release the filled-float to fall down to sea level. The free fall of the filled-float having a heavy mass creates high mechanical energy to be converted to electricity via mechanical connection to an electrical generator.

The float of the present invention may be large and very shallow (up to 9 meters in diameter and about 1-2 meters height) to efficiently use the physical advantage of volume and weight, minimizing friction, to allow long movement from sea level zero, up to top of the wave or back down.

The float may be in the form of a wide cone.

The movement of the wave up and down may be detected by a mechanical and/or an electrical sensor. The mechanical sensor can be a secondary float as described below, the electrical sensor may be an electronic device using pressure, short circuit or other physical measurement as a trigger. After reaching the peak height, the float falls down to the base sea level, where it is locked again by a lock system.

Turning back to FIG. 2, in some embodiments of the invention, the float trigger system includes two sensors wherein the first sensor 12 is positioned near the base sea level ‘0’ and the second sensor 14—near the wave peak height ‘1’. When the sensor 14 detects liquid, it sends a command to trigger the locks which release the float. The float then “jumps” to create energy and floats down as the liquid surface moves back to level ‘0’. When the sensor 12 detects air indicating that the float is located near level ‘0’, it sends commands to lock the float at the base sea level ‘0’.

The two sensors may have an independent servo system that measures the wave average height and can change the sensor 14 position accordingly. On the same time, the system may check for tides and change the sensor 12 position to match the base liquid level.

The float is locked on the sea base level ‘0’ via lockers that operate either mechanically or electrically. A wave raises the liquid surface up to a position identified by the sensors as the peak height of the wave. In this position, the lockers are opened and the float outbursts with a force being equal to the weight of the liquid that is displaced according to Archimedes Law minus the float weight. The vertical motion is transformed into electricity via rotational or linear transformer. When the wave passes through the liquid reservoir (or the floating trigger as the case may be) and the liquid level drops, the buoy floats down on the surface to the sea level ‘0’ on which the lockers are securing the float again to the start position.

Reference is made to FIG. 3 illustrating an alternative configuration in which the float is an elongated hollow member (e.g. having a cylinder shape) and is at least partially immersed in the liquid. In this specific but not limiting example, the length of the float is higher than the maximum liquid level (or wave height) keeping continually a portion of the float above the liquid level. One of the advantages of such configuration is the minimization of the friction forces generated in the outburst and therefore the maximization of the energy production.

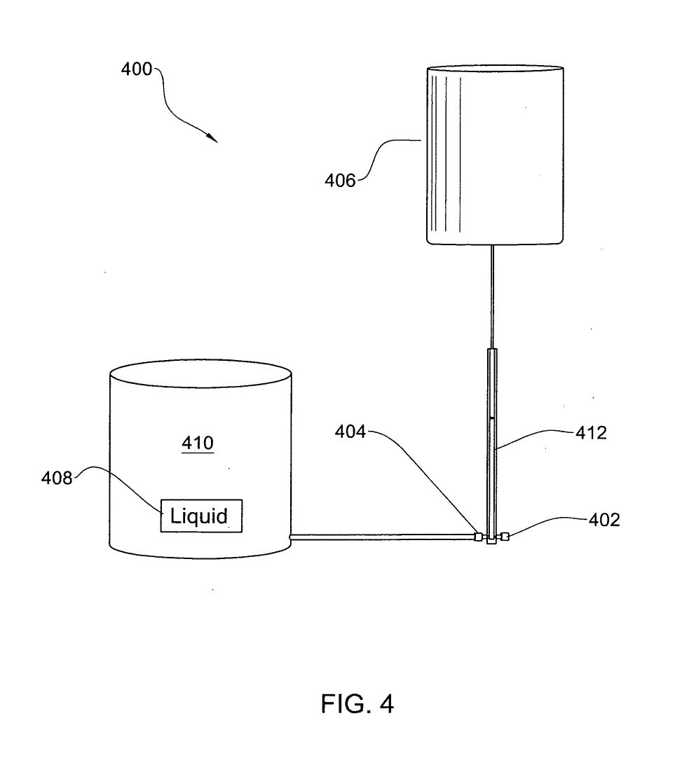

Reference is made to FIG. 4 illustrating another configuration of the energy production system 400 in which the controller system comprises a hydraulic pump 412 configured to compress liquid (e.g. water or hydraulic oil) as the float 406 moves up and down. The pressure reservoir 408 has an upper section containing pressurized gas 410 (air/nitrogen). The pressure rises when a liquid flows into the reservoir 408. The hydraulic pump comprises two one-way valves: an inlet valve 402 and an outlet valve 404. The inlet valve 402 is open while the float 406 moves up, and then closes. When the float 406 floats down, the outlet valve 404 opens enabling the liquid to flow into a main pressure reservoir 408. While the float 406 is in the lower position and the sensor sends a signal, the two electrical activated valves are shut close, preventing the float 406 to float on the surface of the water. When the signal is send to the valves, the system 400 opens the valves enabling water to enter/leave the pump. The liquid may flow through an outlet pipe (not shown) to a turbine to produce electricity.

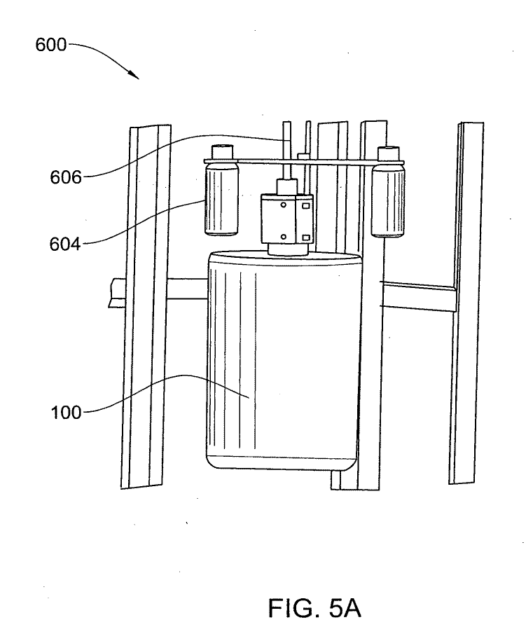

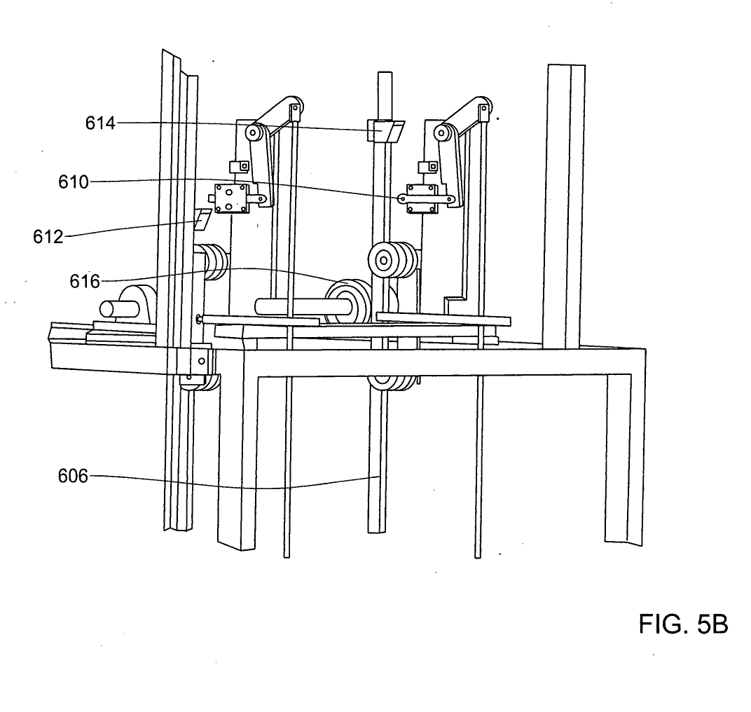

Reference is made to FIG. 5A illustrating another configuration of the lock system 600, positioned above the sea level in this specific example. A rod 606 attached to a float 100 has a mechanical jig (not shown) operable to lock the float. The lock system 600 is attached to the main construction. When the wave crest approaches the lock system 600, it opens via a secondary float 604 (which in turn can be adjusted for a timed release). The float 100 is released and after the wave retreats, the lock system 600 come back to its start (initial) position until the jig automatically locks the lock system 600 again. This configuration may be used underwater as well.

Reference is made to FIG. 5B illustrating an enlarged view of the lock system 600 when the lock system is opened 610 and locked 612. In the locked position, the float (not shown) is locked in the lower position and the jig 614 is maintained by the lock system 600. When the secondary float (not shown) floats on the wave crest, the lock system 600 retreats (shown in the open position) allowing the float to outburst. While the wave leaves the lock system 600, the float floats down until the jig 614 passes through the lock system 600 (which automatically retreats to let the jig pass through) and locks the lock system 600 again.

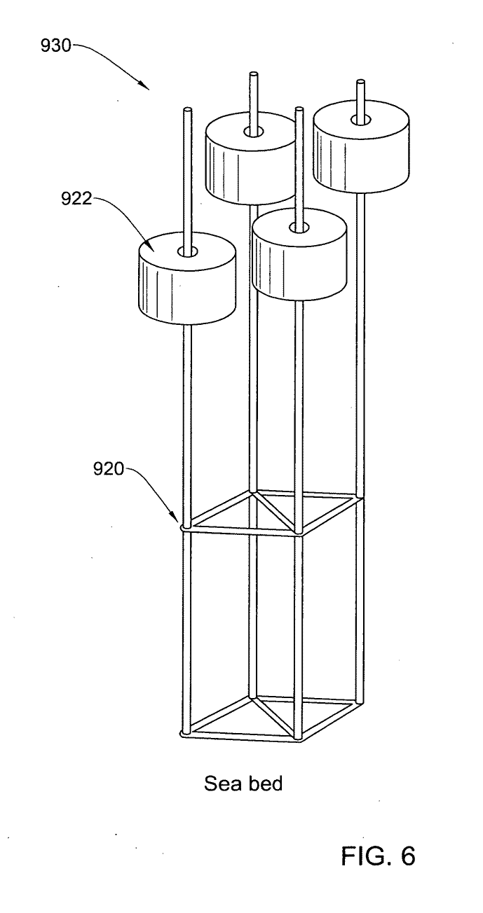

Reference is made to FIG. 6 illustrating a housing structure 930 fixed to the seabed. As described above, in some embodiments, the float may be held at the peak height by a lock attached to a housing structure 930. The housing structure 930 may be a bundle of construction pipes 920 having cylindrical floats 922 riding up and down on the pipes 920. The structure 930 may be secured to the seabed via weights and/or stuck in the seabed with an appropriate technique.

It should be noted that each float can move independently up and down within a structure that contain the necessary equipment for locking the float in its down position, the sensors recognizing the wave height and unleashed the float, the trigger and the locks, and all the elements needed for the production of electricity. The housing may be attached and secured to the seabed. All the electricity needed for operation is produced on site, while the additional current is delivered to shore via an underwater electrical cable.

The sensors may move on a separate rails adopting the height to the base sea level (sensor ‘0’) changing position for tides, and the peak height sensor (sensor ‘1’) may change its position according to the average wave height.

The energy gain using the system of the present invention may be calculated as follows:

Let us assume that the float mass is 0.5 Kg;

The float volume V=πr²h=π(0.5)²0.1=0.0785 m³;

The sea water specific weight

$${ρ}_{SW} = 1027 \frac{Kg}{{m}^{s}} ;$$

The air specific weight

$${\_ρ}_{A} = 1.225 \frac{Kg}{{m}^{s}} ;$$

Law of buoyancy, (Archimedes law), states that any object that is completely or partially immerged in a fluid at rest, is acted on by an upward, or buoyant, force. The magnitude of this force is equal to the weight of the fluid displaced by the object. The volume of fluid displaced is equal to the volume of the portion of the object immerged.

The mass of displaced water is ρ_{sw}*V=1027*0.0785=80.66 Kg

The work done is:

$$work = w = Δ E = {\int }_{0}^{h} F d s = 784.8 [ Nt ] * 10 [ m ] = 7848 J$$

For comparison, the amount of energy produced by the same buoy potential energy “riding” on the water surface is about 60 J, i.e. 134 less than the energy obtained with the system of the present invention.

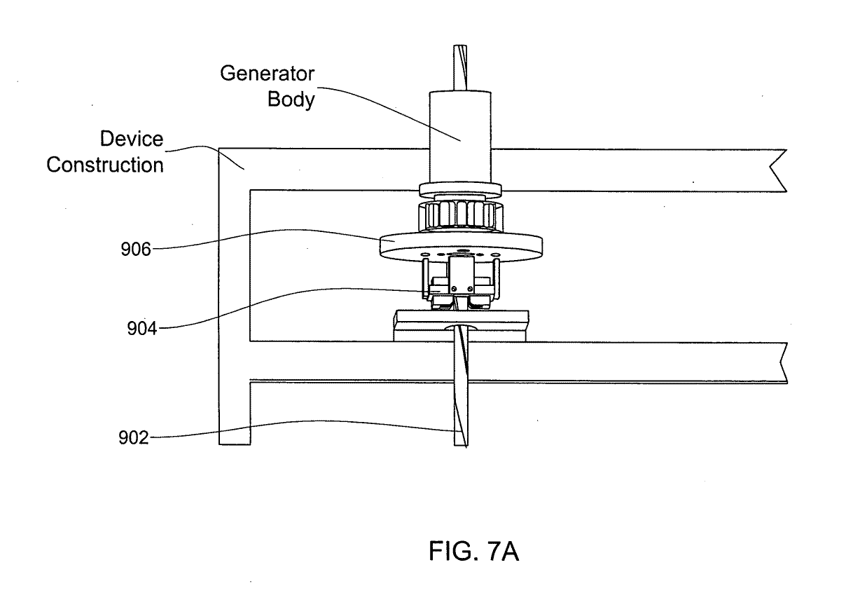

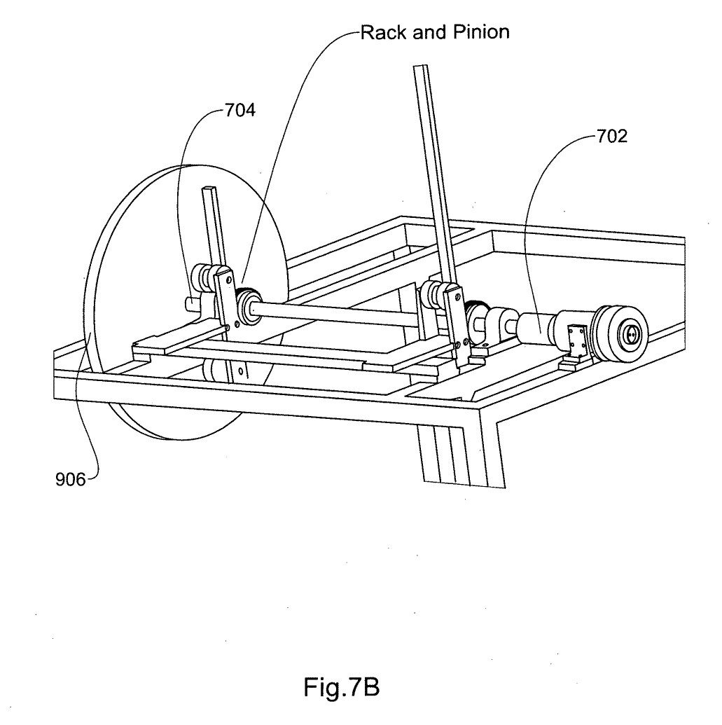

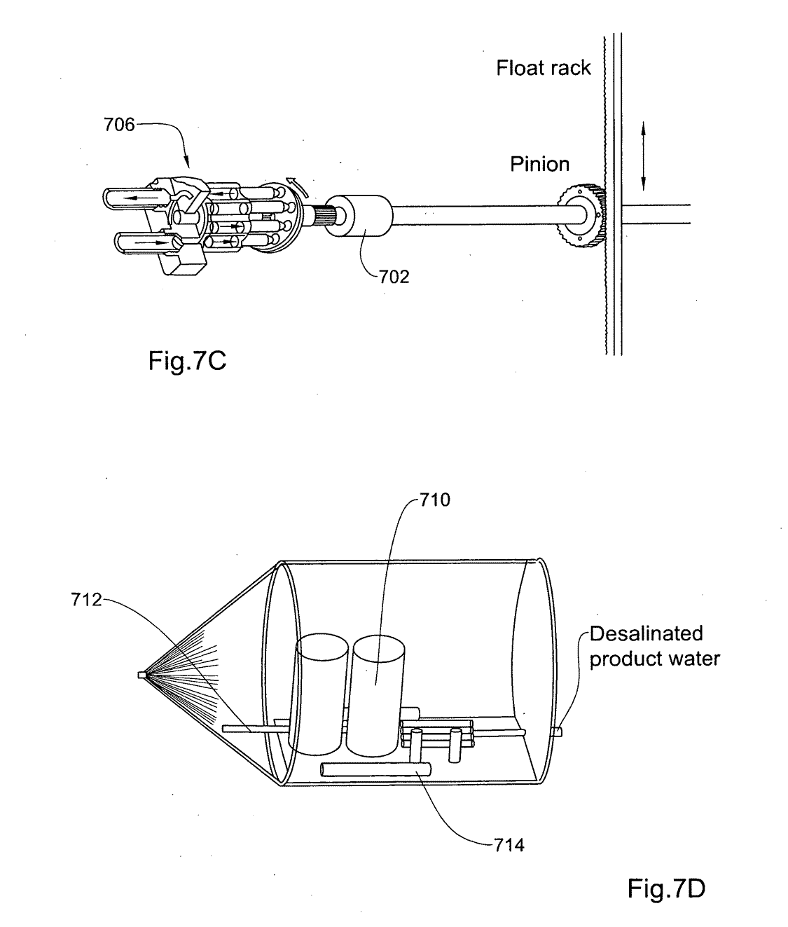

Reference is made to FIG. 7A illustrating an example of a linear transformer 900 operable to transform the linear motion of the float into a rotational motion with high efficiency according to the teachings of the present invention. As described above, when the float outburst and reaches the surface of the liquid, a rod (e.g. grooved) 902 attached to the float is raised. While moving up, the rod 902 raised an impact transmitter 904 to its upper position to be inserted into the grooves of an inertial wheel 906. The impact transmitter 904 has preferably a polygonal (e.g. rectangular) groove that allows only linear motion (up and down) on the rod 902 or rotation when the linear movement is suppressed In other words, the impact transmitter moves up when the float moves up linearly, up to the point when the impact transmitter connects with the inertial wheel via the rectangular grooves. At this point, the connected impact transmitter and the inertial wheel can make only a rotational motion since the float has two grooves that force the float to slide linearly on the main structure and prevent the float rotation.

When the inertial wheel 906 and the impact transmitter 904 are locked together, the linear motion of the rod 902 is transformed to a rotational motion, rotating the generator main rod and producing electricity.

After the wave crest passes the device, the impact transmitter 904 falls down by gravity forces and is disconnected from the inertial wheel 906 that continue to rotate, lengthening the production of electricity, before the next wave cycle.

Reference is made to FIG. 7B, illustrating another configuration of a linear transformer of the energy production system of the present invention. In this specific example, the linear electric generator comprises a rotational shaft 704 connected directly or indirectly to a pump that forces the liquid (e.g. sea water) to pass through a RO unit to desalinate the sea water and pump the potable water to the shore. The pump may be of any known suitable type e.g. of configuration described above in connection with FIG. 4.

Using the configuration illustrated in the figure, the efficiency of the transformation is high by using an inertial wheel 906, the use of which improves the device ability to work with constant velocity. The transformer comprises a clutch 702 configured and operable to engage a pump into the rotational shaft 704 when the shaft rotates at an appropriate speed. It should be noted that the RO unit may be located at the base of the liquid reservoir or at the top of it. The desalted water may be brought, by means of large diameter pipes, to service reservoirs on the shore.

It should be noted that the energy production system of the present invention is appropriately designed and constructed, to be sunk into the ocean anywhere along the continental shelf, to an approximate depth of 600 meters below the free sea or ocean surface—where the water pressure is compatible with the reverse osmosis. Therefore, using this configuration, there is no need to pump and transport the sea water to the shore to be desalinated, in which a large amount of energy is required, the desalination is performed into the ocean, and only the desalted water is brought to the shore. Moreover, using this configuration, the brine stream is continuously poured to the ocean and mixed with the sea water avoiding the “sea desert” and damage to ocean ecology.

Generally, the functional requirements of the RO element determine the depth to which the energy production system needs to be located, to attain the necessary pressures for reverse osmosis, and the amount of saline water passing over the RO element to achieve the required quality of the desalted water.

Reference is made to FIG. 7C illustrating the transformer of FIG. 7B in which the clutch 702 is connected to a pump 706 forcing the sea water to pass through a RO unit (not shown). To use reverse osmosis process, high pressure is needed to force the water to pass through the RO unit, retaining the salt on one side and allowing the pure water to pass to the other side. In the energy production system of the present invention, a pump (e.g. variable piston booster pump) 706 generating a pressure of about 60-80 Atms, sucks the water from the ocean and pushes them through the RO unit. A pipe may be used to suck the sea water from the ocean. Another pipe (e.g. low pressure flexible pipe) connected to the energy production system of the invention may transport the desalinated water to the shore.

All the components of the energy production system are sealed in a housing which is operable against ocean forces and corrosion of sea water. The pump and the clutch may be connected to the shaft through a sealed box.

Reference is made to FIG. 7D, illustrating another configuration of a system of the present invention configured and operable for liquid (e.g. sea water) desalination by using reverse osmosis (RO) process. In this configuration, the desalination of the liquid is performed directly by wave energy (generally, energy produced by the liquid level difference) using buoyancy forces. The liquid flow, created by the mechanical vertical power (mechanical energy) generated by the float outbursting all the way defined by the liquid level difference, is forced to pass through a RO unit 710. The RO unit 710 is therefore located in a path of the liquid passing through or emerging from the reservoir. The mechanical vertical power generated by the float outbursting the liquid level difference path within the liquid reservoir enables to attain the necessary pressure for reverse osmosis. In other words, the flow of liquid created by the movement of the float (i.e. by the mechanical energy) generates a pressurized liquid which can be directly used as a certain amount of saline water passing over the RO unit to achieve the required quality of the desalted water. The desalination of the liquid is therefore performed directly by wave energy using buoyancy forces, thereby eliminating or at least reducing a need for an external energy such as a pump to activate the RO unit. It should be noted that the RO unit may be of any known suitable type, e.g. including a set of filters and/or RO elements (e.g. semi-permeable membrane). In this specific example, the RO unit 710 is enclosed in a housing sealed against leaks of water and withstands the pressure of up to 10 atmospheres. In some embodiments, the RO unit lies in the sea bed, secure from the elements and forces of the wind/water.

In some embodiments, the efficiency of the system might be further improved by associating the RO unit with an external energy source such as a turbine or electrical motor, or a linear electric generator according to the present invention. A flexible pressure pipe 712 connecting between a pump 706 and the RO unit 710 may transfer the pressurized sea water down to the sea bed. Another flexible pipe accommodating the desalinated water drives the water to shore. The housing comprises ballast tank(s) 714 full of air, enabling the device to float on the sea water. When the pipe 712 is filled with sea water, the pump 706 transfers the water to the ballast tank(s) 714 which are then also filled with the water, causing the energy production system to sink to the ocean bed. Reaching the sea bed, the energy production system is secured to the bed via anchors to keep it steady in place.

In other embodiments, the transformer includes an electrolysis unit in which the sea water is break down with electricity to form hydrogen and oxygen. Therefore the present invention enables the production, storing, and supplying of substantial amounts of hydrogen and/or oxygen gas(es) which has (have) been captured by electrolytic conversion of tidal and wave energy.

Such electrolysis unit includes inter alia chargeable electrodes for placing in sea water, which are electrically conductive. When delivered to the land, the hydrogen and oxygen can be reconverted into electricity with high efficiency by use of hydrogen-oxygen fuel cells. As described above, the mechanical vertical power generated by the float outbursting all the way to the wave peak is transformed to an electrical rotating turbine or linear electric generator which is attached to the float. In a specific example, the electrical rotating turbine or the linear electric generator which is connected to electrodes located in the liquid reservoir. The liquid reservoir being in liquid communication with the surrounding ocean is partially filled with sea water which totally submerses the electrodes. Baffles and appropriate separators may separate the electrodes so that the gases generated in the vicinity of each electrode, may be separately collected, or separately vented to the atmosphere, as desired. A compressor, driven either manually by the shaft or electrically by the output of the generator, compresses the hydrogen gas drawn from a hydrogen containing chamber located in the top of the liquid reservoir, for transmission and storage in the floats.

As described above, the electrolysis unit may comprise two electrodes, which may be of the type commonly used in lead batteries, disposed in the liquid reservoir below the base level “0” illustrated in FIG. 2. The electrodes are oppositely charged by the generator so that an electrical potential is created between them, causing an electrical current to flow through the water between the electrodes. As a result of this current, a portion of the water dissociates into hydrogen and oxygen molecules by an electrolysis process, the hydrogen molecules adhering to one electrode (e.g. cathode electrode) and the oxygen molecules adhering to the other electrode (e.g. anode electrode).

A separator such as a microporous barrier, which may be of the type commonly used as battery separators, may be mounted between the electrodes. The microporous barrier allows the water to pass freely across it but is impervious to gases. Thus, the microporous barrier ensures that the hydrogen and oxygen molecules forming on the electrodes remain separated. After dissociation, the hydrogen and oxygen molecules form bubbles which rise through the water and are collected in a collecting region situated in the top of the liquid reservoir. A baffle may be disposed above, and contiguous with, the macroporous barrier to divide the collecting region into two portions so that the hydrogen and oxygen remain separate. From the top of the liquid reservoir, the hydrogen and oxygen are drawn into a compressor for compression therein. The compressor is disposed above the top of the liquid reservoir and the hydrogen and oxygen enter the compressor through intake conduits. The compressed hydrogen and oxygen from the compressor are directed, via conduits, to a float for storage. In the float, the oxygen and hydrogen are stored in separate portions, formed in the float by two vertically extending baffles.

Alternatively, if it were deemed undesirable or uneconomical to store both the hydrogen and the oxygen produced, the oxygen could be vented to atmosphere, rather than drawn into the compressor. In this case, the aforementioned baffles would be unnecessary and the entire volume within the float could be utilized for the storage of hydrogen.

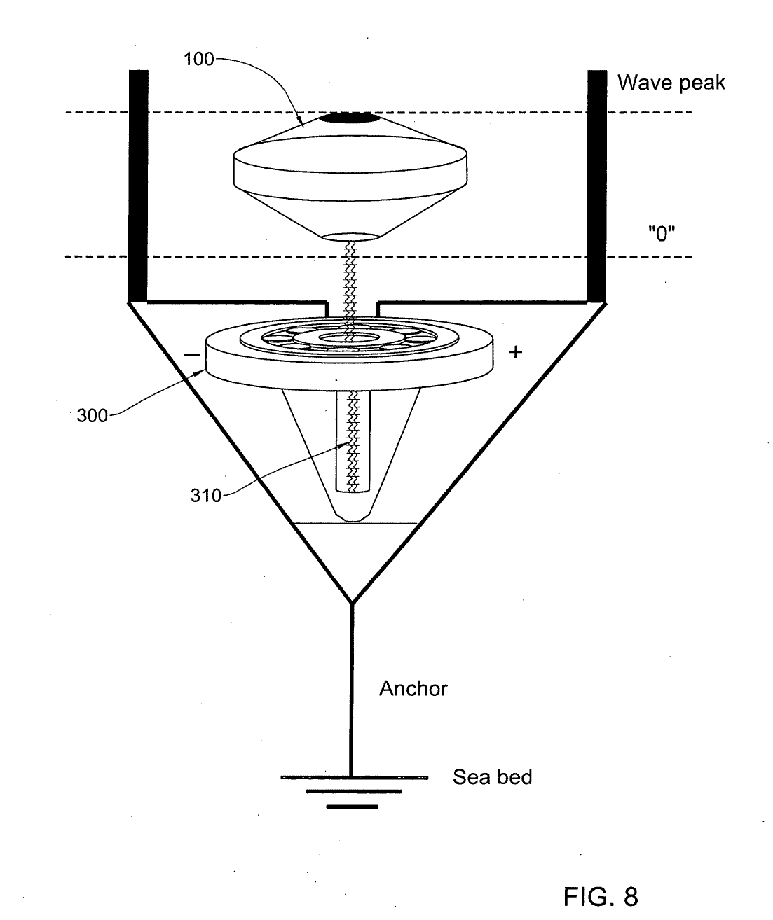

Reference is made to FIG. 8 illustrating another configuration of the rotational transformer converting the vertical motion of the float into electrical power. The rotational transformer 300 may have a spiral rod 310 connected to the float 100 passing through a rectangular nut with bearing balls to reduce friction. When the float 100 bursts up, the spiral rod 310, while passing through the rectangular nut, forces a magnet to rotate and thus creates electrical forces on the coil wires and produces electricity. The rotational transformer 300 may be associated with a clutch operable to disengage the connection during the float 100 and the spiral rod 310 motion without stopping the magnet spin.

Alternatively, the transformer may be a linear transformer having a constant magnet attached to the float and an electrical coil around the magnet. During the float motion up and down, the magnet moves through the coil which is permanently anchored to the seabed, producing electrical current in the coil wires. The linear/rotational transformer may be one of the following: a flywheel; a crankshaft; a ratchet (i.e. a device that allows linear or rotary motion in only one direction, while preventing motion in the opposite direction); gear wheels that transform vertical move to horizontal; one-way combined gear wheels and linear toothed rod; a clutch device using friction; and a pulley and cable assembly.

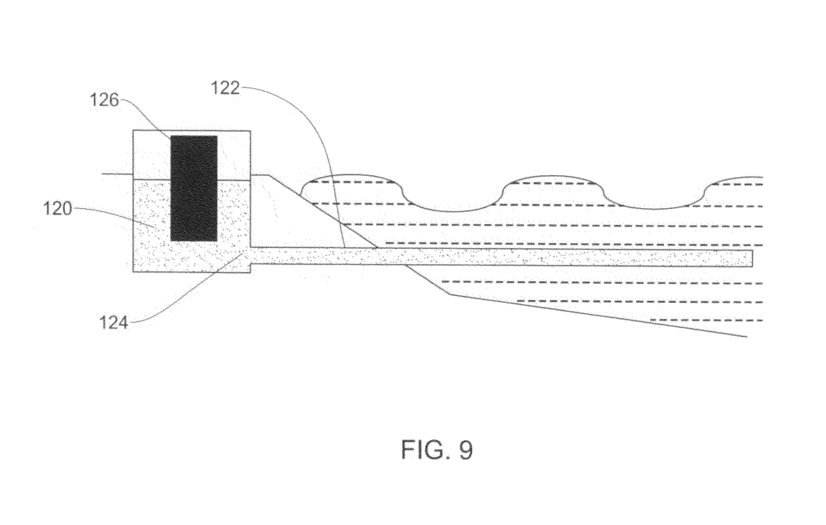

In some embodiments, the floating trigger system of the present invention may be accommodated on the ground, as an on-shore liquid reservoir having a liquid level corresponding to the wave height. In this connection, reference is made to FIG. 9, representing an on-shore liquid reservoir 120. The liquid reservoir 120 may be filled using marine pipes 122 that can compensate for the amount of liquid that is entering the reservoir. In this configuration, the water level in the liquid reservoir has the same level than the wave level because of the connected vessels principle. The float operation is similar to it operation off shore.

Using this configuration, the liquid may be stored at a certain height compensating for wave motion, enabling the production of electricity as long as the reservoir can supply liquid. Moreover, the liquid height may be maintained constant using of vertical pipe (cylinder) with two one-way valves (in & out) enabling the production of electricity at a constant liquid level and at constant peaks pace.

The pipe diameter may have a minimal space around the float allowing a minimal waste of liquid while the liquid is drained out of the pipe.

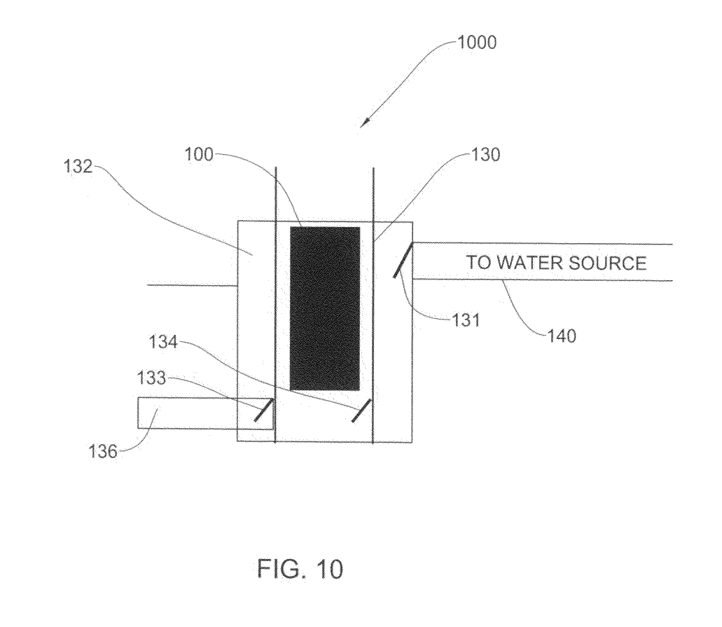

Reference is made to FIG. 10 illustrating a liquid reservoir system 1000 in liquid communication with a water source 140 via a valve 131 constituting the inlet of the reservoir. This may for example be a “land” reservoir system. A liquid reservoir 130 may be any liquid reservoir which can be emptied and refilled using a liquid pipe 132 (e.g. cylinder) and a respective valve 134 placed at a minimal height with respect to the reservoir. The float 100 is accommodated in the reservoir 130. Thus, in this example, the reservoir 130 comprises two valves: one-way inlet valve 134 operable to fill the reservoir 130, and one-way valve 136 associated with an outlet draining pipe and operable to empty the reservoir. When the liquid level is down to empty in the reservoir 130, the float 100 drops all the way to the bottom level of the reservoir 130 and is locked by a locking system (not shown). The liquid pipe 132 is then filled up from the water source via its associated valve 131 and the pipe-valve 134, creating a mass of liquid surrounding the float 100.

The system 1000 of the present invention comprises a controller (not shown here) which opens the outlet valve 136 and the liquid is drained from the liquid pipe 132. The float falls by gravitation to a level where the locker locks the float. The controller closes the outlet valve 136 and opens the inlet valve 134, allowing the liquid from the reservoir 132 to fill the liquid pipe 130 to a predetermined level. When the liquid reaches the predetermined level within the liquid reservoir 130, the controller closes the inlet valve 134, and the liquid is stored at a certain height. The trigger then releases the float which outbursts upward to produce mechanical energy to further produce electricity and/or use the resulted high pressure liquid flow in any other manner. When there is no desired liquid supply from the reservoir part surrounding the pipe 130, the system inlet valve 131 associated with the main water source is opened and a further cycle proceeds. Thus, liquid is allowed to enter the inner part of reservoir. When the float reaches the liquid surface, the controller closes the inlet valve 134 and opens the outlet valve 136 to empty the liquid and start the all cycle again.

1. A system comprising:
at least one liquid reservoir having a predetermined arrangement of inlet and outlet to provide a periodically changes in a liquid level in the reservoir resulting from liquid passage through the reservoir via said inlet and outlet,
at least one float at least partially immersed in liquid within the liquid reservoir, a lock system operable to maintain said at least one float at a predetermined base level in said liquid, and a controller system comprising a trigger system operable to selectively trigger said lock system to release the float upon identifying a predetermined condition of the float relative to the liquid level, thus enabling movement of the float creating high mechanical energy from the liquid level difference within said liquid reservoir, thereby enabling use of said high mechanical energy for producing energy.

2. The system according to claim 1, wherein said predetermined base level is the lowest liquid level in said liquid reservoir, the predetermined condition of the float being its location at the lowest liquid level, the float being released from the lowest liquid level.

3. The system according to claim 2, wherein said predetermined base level is a trough of a wave height, the float being released at a peak crest of the wave.

4. The system according to claim 1, comprising a reverse osmosis unit for desalinating liquid passing therethrough.

5. The system according to claim 4, wherein said reverse osmosis unit is located in a path of the liquid passing through or emerging from said reservoir, the liquid being forced to pass through the reverse osmosis unit by said mechanical energy thus desalinating the liquid.

6. The system according to claim 4, wherein the desalination of the liquid is performed directly by wave energy using buoyancy forces, thereby eliminating a need for an external energy to activate the reverse osmosis unit.

7. The system according to claim 1, comprising an electrolysis unit operable by said mechanical energy via a generator inducing a portion of the liquid to dissociate into hydrogen and oxygen molecules by an electrolysis process.

8. The system according to claim 1, wherein at least one of the inlet and outlet is connected to a mechanical unit configured and operable to assist liquid passage through the reservoir.

9. The system according to claim 1, wherein the controller system is configured and operable to control said periodical change in the liquid level in the reservoir in accordance with a predetermined wave-model.

10. The system according to claim 1, comprising a transformer configured and operable to transform a linear movement of the float into a rotational movement, wherein said transformer comprises a rod attached to said float, an impact transmitter having a polygonal groove accommodating said rod, an inertial wheel operable to be locked together with said impact transmitter, and a generator having a main rod such that the linear motion of said rod is transformed into a rotational motion, rotating said main rod to produce electricity.

11. The system according to claim 1, configured to be operable on the land using the on-shore liquid reservoir.

12. The system according to claim 1, wherein said controller system is operable to open and close said liquid reservoir in a liquid source, filling and emptying said reservoir from said liquid source using at least one of the following: gravity forces and connected vessels principle such that the liquid level in said liquid in the reservoir changes periodically.

13. The system according to claim 1, wherein the liquid in the reservoir changes its level with a certain constant periodicity and with the constant liquid level difference, enabling a continuous homogeneous production of high mechanical energy.

14. The energy production system according to claim 1, wherein said liquid reservoir is a pool in a liquid communication with a water source, said water source being at least one of the following: an industrial cooling water, a liquid tower, liquid gate, river, lake, sea, stream, ocean, darn, fresh liquid reservoirs, local sewage systems and drainers.

15. An energy production system comprising:
at least one liquid reservoir having a predetermined arrangement of inlet and outlet to provide a periodically changes in a liquid level in the reservoir resulting from liquid passage through the reservoir via said inlet and outlet,
at least one float at least partially immersed in liquid within said liquid reservoir, a lock system operable to maintain said at least one float at a predetermined base level in said liquid, and a controller system configured and operable to selectively operate said lock system to release the float upon identifying a predetermined condition of the float relative to the liquid level thus enabling movement of the float creating high mechanical energy from the liquid level difference within said liquid reservoir, thereby enabling use of said high mechanical energy for the energy production.

16. A reverse osmosis system comprising:
a liquid reservoir configured such that a liquid periodically changes its level in the reservoir;
at least one float at least partially immersed in liquid within said liquid reservoir;
a lock system operable to controllably maintain said float at a predetermined base level in said liquid reservoir;
a controller system configured and operable to selectively operate said lock system to release the float upon identifying a predetermined condition of the float relative to the liquid level thus causing movement of the float creating high mechanical energy from the liquid level difference within said liquid reservoir; and
a reverse osmosis unit located in a path of the liquid passing through or emerging from said reservoir, the liquid being forced to pass through the reverse osmosis unit by said mechanical energy thus desalinating the liquid.

17. The reverse osmosis system according to claim 16, wherein said liquid reservoir is selected from a pool of a liquid tower, liquid gate, river, lake, sea, stream, ocean, dam, fresh liquid reservoirs, local sewage systems and drainers.

18. A system comprising:
a liquid reservoir in which liquid level periodically changes, at least one float at least partially immerged in liquid within the liquid reservoir, a lock system operable to maintain said at least one float at a predetermined base level in said liquid, and a controller system comprising a trigger system operable to selectively trigger said lock system to release the float upon identifying a predetermined condition of the float relative to the liquid level thus enabling movement of the float creating high mechanical energy from the liquid level difference within said liquid reservoir, thereby enabling use of said high mechanical energy for energy production.

19. A method of production of mechanical energy, the method comprising: providing liquid passage through a liquid reservoir with a periodical change of a liquid level in the reservoir, while holding a float at a predetermined level in the reservoir such that said float is at least partially immersed in a liquid within the liquid reservoir; and selectively releasing said float to allow said float to outburst using buoyancy forces creating large amount of mechanical energy.
